(19) United States
(12) Patent Application Publication
(10) Pub. No.: US 2021/0046780 A1
(43) Pub. Date: Feb. 18, 2021

(54) SUPPORT DEVICE FOR SECURING SHEET MATERIAL TO A BACKING SURFACE AND METHOD OF USING SAME

(71) Applicant: Kojo WHITE, VANCE, AL (US)

(72) Inventor: Kojo WHITE, VANCE, AL (US)

(21) Appl. No.: 16/990,403

(22) Filed: Aug. 11, 2020

Related U.S. Application Data
(60) Provisional application No. 62/887,108, filed on Aug. 15, 2019.

(51) Int. Cl. B42F 15/06; F16M 13/02

(52) U.S. Cl. CPC B42F 15/06; F16M 13/02

(57) ABSTRACT

A device for securing sheet materials to a surface includes main body having a side wall which connects top and bottom surfaces and a channel which extends along a central portion of the top surface, a member which operatively connects in the channel and moves relative to the channel. The bottom surface flushly engages the surface when the main body is secured thereto, a projection extends from a portion of the side wall outward and at an angle to the side wall, the projection having a free end which is normally disposed at a level which is different from a level of the bottom surface so that when the main body is attached to the surface a gap is defined between the free end and the surface. When the main body is fastened to the surface and the member is moved relative to the channel the side wall is also moved and changes a width of the gap.

### BACKGROUND OF THE INVENTION

### Field of the Invention

The present invention relates to a device for easily and stably securing sheet materials such as paper sheets, documents, posters, etc. to a backing surface. More particularly, the present invention pertains to such a device in the form of a support member which may be fastened flush against the backing surface and includes a projection which may be easily manipulated for clamping sheet materials between the support member and the backing surface.

### Description of the Background Art

There are many known devices for easily and stably securing sheet materials such as paper sheets, documents, posters, etc. to a planar backing surface. These include the devices disclosed in the following US Patents and US Patent Application Publications:

U.S. Pat. No. 4,085,848A: Holder device for suspending articles such as paper and the like;
U.S. Pat. No. 2,231,883A: Holder for articles;
U.S. Pat. No. 6,302,362B1: Paper holder;
U.S. Pat. No. 4,629,075A: Mounting Strip;
U.S. Pat. No. 4,717,110A: Adjustable signage system;
U.S. Pat. No. 1,602,341A: Sheet Supporting Device;
U.S. Pat. No. 2,530,821A: Bulletin sheet holder and support;
U.S. Pat. No. 1,759,781A: Price tag or sign holder;
U.S. Pat. No. 4,105,127A Holder Bar for Flexible Sheet-Like Articles; and
US 2016/0107474A1: Sheet holder.

While the known devices are suitable for their intended functions, they still remain to be improved upon. For example, the device in U.S. Pat. No. 4,085,848 is relatively complicated, including a number of balls which are slidably retained within a retainer in a series arrangement with each other, while the retainer may be attached to a surface to define a gap between a lower portion of the retainer and the surface so that the upper portion of one or more thin sheets or the like may be pushed upward through gap and the balls will secure-clamp the upper portion(s) of the sheets against the surface by force of gravity. Also, this device obstructs a relatively large upper portion of the thin sheet(s) which are gripped by the balls of the device. Other know devices, such as those disclosed in U.S. Pat. Nos. 2,530,821, 4,105,127 and 4,629,075 include some type of spring to grip or clamp a portion of a thin sheet such that the gripped portion of the sheet is spaced away from the backing surface, which is undesirable, and the springs may lose gripping ability over time.

Hence there remains a need in the art for an inexpensive, device which can easily and stably securing sheet materials such as paper sheets, documents, posters, etc. to a backing surface, while overcoming the drawbacks of the known devices.

### SUMMARY OF THE INVENTION

It is an object of the invention to provide a device which satisfies the discussed need, and a method of using same.

According to one aspect of the present invention, there is provided a support device for securing sheet materials to a support surface, comprising:
an elongate main body having a side wall which connects top and bottom surfaces of the main body and a channel which extends in a longitudinal direction along a central portion of the main body's top surface;
a manipulateable member which is configured to be operatively connected in the channel and to be moved relative to the channel; and
a fastener which secures the main body to the support surface, wherein
the bottom surface of the main body is flat or substantially flat and is configured to flushly engage the support surface when the main body is secured to the support surface,
the main body includes a projection which extends from a portion of the side wall outward and at an angle to the side wall, the projection having a free end which is normally disposed at a level which is slightly different from a level of the bottom surface of the main body so that when the main body is attached to the support surface a gap will be defined between the free end of the projection and the support surface, and
the manipulateable member and the channel are configured such that when the main body is fastened to the support surface and the manipulateable member is moved relative to the channel the portion of the side wall from which the projection extends is also moved and changes a width of the gap defined between the free end of the projection and the support surface.

According to a second aspect of the present invention, in addition to the first aspect, the channel has a substantially uniform width along the longitudinal direction of the main body, the manipulatable member has first portion which is configured to be operatively disposed in the channel in engagement with a surface of the channel and a second portion which is configured to be manipulated by a user for moving the manipulatable member relative to the main body, and the first portion has a cam surface provided therewith which selectively engages the channel surface when the manipulatable member is moved relative to the main body to thereby move the side wall and change the width of the gap defined between the free end of the projection and the support surface.

The support device according to the first aspect and second aspects of the invention is very advantageous because it can be used for easily securing thin sheets such as notices and posters against a flat or substantially flat support surface such that the thin sheets may be observed and read by persons in the vicinity of same, and for easily releasing the thin sheets when desired. Also, it is relatively non-complicated and may be inexpensively manufactured.

According to a third aspect of the present invention, in addition to the first aspect, the second portion of the manipulatable member extends outside of the channel when the first portion is operatively disposed in the channel, and the second portion is configured to be gripped and manipulated by a user.

The support device according to the third aspect of the invention is advantageous because it provides a simple and convenient means for selectively adjusting the width of the gap, for thereby gripping or releasing sheet materials by or from the support device.

According to a forth aspect of the present invention, in addition to the first aspect, the channel has a varying width along the longitudinal direction of the main body including wide and narrow portions, when the manipulateable member is connected in the channel and is moved to the narrow portion of the channel the manipulateable member pushes the side wall of the main body outward to thereby cause the width of the gap to be smaller, and when the manipulateable member is moved to the wide portion of the channel the manipulateable member does not push the side wall outward to thereby cause the width of the gap to be larger.

According to a fifth aspect of the present invention, in addition to the first aspect, the side wall of the main body has a weakened portion at which the side wall flexes when the manipulateable member is moved relative to the channel.

According to a sixth aspect of the present invention, in addition to the first and fifth aspects, the channel opens upward in the top surface of the main body, the portion of the side wall to which the projection is connected is near the top surface of the main body, and the weakened portion of the side wall is near the bottom surface of the main body.

The support device according to the fifth and sixth aspects of the invention is also very advantageous because provision of the weakened portion of the side wall and the disposition of the weakened portion and the projection respectively near bottom and top surfaces of the main body facilitates the manipulations of the manipulatable member for changing the width of the gap.

### Intent of Disclosure

Although the following disclosure offered for public dissemination is detailed to ensure adequacy and aid in understanding of the invention, this is not intended to prejudice that purpose of a patent which is to cover each new inventive concept therein no matter how it may later be disguised by variations in form or additions of further improvements. The claims at the end hereof are the chief aid toward this purpose, as it is these that meet the requirement of pointing out the improvements, combinations and methods in which the inventive concepts are found. There has been chosen a specific exemplary embodiment of a submersible foliage planter according to the invention and specific alternative structures and modifications thereto, the embodiment having been chosen for the purposes of illustration and description of the structure and method of the invention are shown in the accompanying drawings forming a part of the specification.

For a more complete understanding of the present invention, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

FIG. 1 is a top perspective view of an exemplary embodiment of a main body of a support device according to the present invention.

FIG. 2 is a bottom perspective view of the main body of FIG. 1.

FIG. 3 is a top plan view of the main body of FIG. 1.

FIG. 4 is a side elevational view of the main body of FIG. 1.

FIG. 5 is a end elevational view of the main body of FIG. 1.

FIG. 6 is a bottom plan view of the main body of FIG. 1.

FIG. 7 is a top perspective view similar to FIG. 1, but also depicting a manipulateable member which is fitted in a channel of the main body of FIG. 1 and two other manipulateable members separate from the main body.

FIG. 8 is a top plan view similar to FIG. 7 but depicting another exemplary embodiment of a support device according to the present invention.

FIG. 9 is a top plan view of the main body of FIG. 8.

### DETAILED DESCRIPTION OF PRESENT EMBODIMENTS

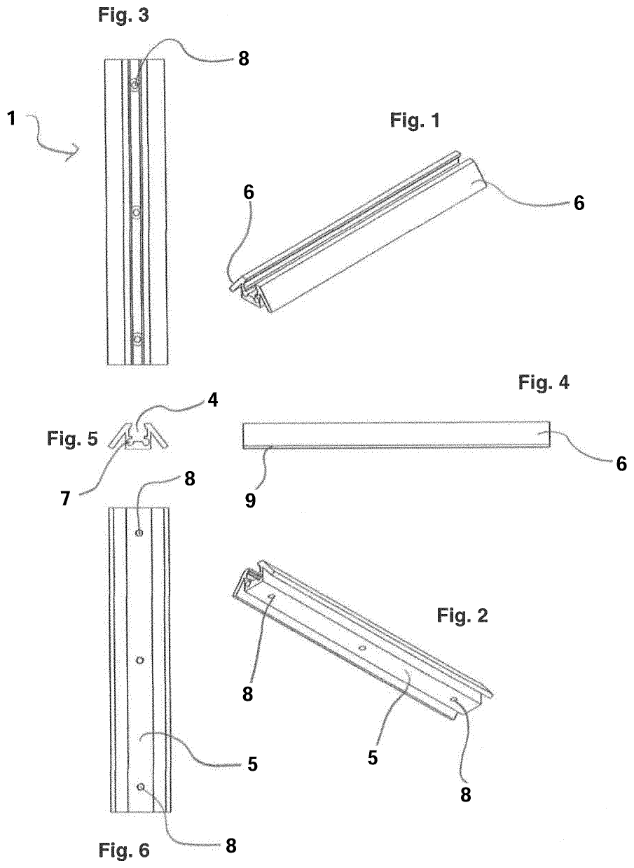

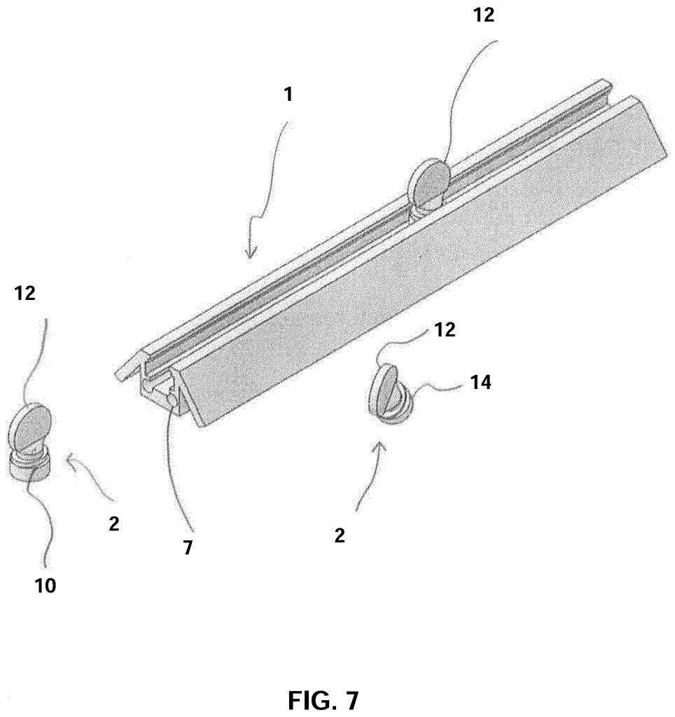

With reference to FIGS. 1-7, there is shown an exemplary embodiment of a support device according to the present invention, with FIGS. 1-6 showing a main body 1 of the support device and FIG. 7 also showing manipulateable members 2 that operatively connect to the main body and which can be manually manipulated to adjust the main member between gripping and release positions thereof when the main body is attached to a flat or substantially flat support surface by changing a width of a gap between a free end/edge of a projection 6 extending from the main body and the support surface.

Referring to FIGS. 1-7 the main body 1 according to this embodiment may be a linearly extending member, which may be of any desired length in a longitudinal direction thereof and any desired width such as 0.5-2.0 inches. The main body 1 may be composed of any rigid or substantially rigid material, including plastics, thermoplastics, aluminum, aluminum alloys, wood, etc. If the main body is composed of a plastics or thermoplastic, it may be formed by molding, injection molding, extrusion or other appropriate manner. If the main body is formed from aluminum or an aluminum alloy it may be formed by casting, extrusion or any other appropriate manner.

As depicted, the main body 1 may have a central channel 4 that extends longitudinally thereof, is open at the opposite ends of the main body and opens upward at an upper end of the main body, projections 6 provided on one side or opposite sides of the main body, and one or more openings 8 provided in a bottom surface 5 of the main body below the channel 4 and which would receive screws (not shown) or other fasteners therethrough for securing the main body to a flat support surface (not shown) such as a vertically-extending wall. Each of the projection(s) 6 may extend the full length of the main body and may project from an upper portion of the main body adjacent the open end of the channel 4 and extend laterally away from the main body at an angle such that a free end/edge of the projection extends almost to a level even with the bottom surface 5 of the main body, which is beneath the channel 4. If two of the projections 6 are provided with the main body, they may be disposed symmetrically on opposite sides of the main body any appear like wings extending from the main body as in the end view of FIG. 5. By providing the projections 6 on opposite sides of the main member, a single support device may be used to secure sheet materials on opposite sides thereof simultaneously, or if one of the projections becomes damaged/broken the main member 1 could be rotated 180° and the other projection could then be used in place of the broken projection for increased useful life of the support device. Because the channel 4 is open at opposite ends of the main body, each of the manipulatable members 2 may be easily attached to the main body by inserting/sliding a lower portion of the manipulatable member into the channel 4 from either end of the main body and then sliding the manipulateable member to a desired position along the channel. For detaching the manipulatable member from the main body, the process is reversed. Of course, it is possible to close both ends of the channel 4 such that the manipulatable member(s) 2 remain connected in the channel at all times, or to close one end of the channel if so desired.

Due to the structure whereby the free end/edge of the projection extends almost to a level even with the bottom surface 5 of the main body, when the main body is attached to a flat or substantially flat support surface, there will be a slight gap 9 (see FIG. 4) between the free end/edge of the projection and the flat or substantially flat support surface to which the main body 1 is attached. The gap 9, although it may be quite narrow, is sufficiently wide, e.g., 0.5-1.0 mm, to permit edges of one or more sheets of paper or other thin sheet material to be inserted into the gap 9 between the free end/edge of the projection and the flat or substantially flat support surface to which the main body 1 is attached. Then one or more of the manipulatable members 2 may be used to force the free end/edge of the projection closer to the flat or substantially flat support surface, and thereby clamp/secure the edge(s) of one or more sheets of paper or other thin sheet material between the free end/edge of the projection and the flat or substantially flat support surface as discussed further below.

Referring to FIG. 7, the manipulatable members 2 may have a substantially cylindrical lower portion 10 which may be securely received in the channel 4 of the main body 1 and an upper portion 12 which extends outside of the channel 4 and may be grasped by a user, e.g., between the thumb and forefinger of a hand of the user, so that the user may easily manipulate the member 2 while gripping the upper portion 12. The manipulatable member 2 may also be composed of any rigid or substantially rigid material, including plastics, thermoplastics, aluminum, aluminum alloys, wood, etc. If the manipulatable member 2 is composed of a plastics or thermoplastic, it may be formed by molding, injection molding, extrusion or other appropriate manner. If the manipulatable member is formed from aluminum or an aluminum alloy it may be formed by casting, extrusion or any other appropriate manner.

As depicted the lower portion 10 of the manipulatable member may include a cam surface 14 on one section thereof such that it is not perfectly circular in cross section, but has different widths therearound. When facing in a first direction such that the cam surface 14 extends generally in a longitudinal direction of the channel 4, the lower portion 10 of the manipulatable member 2 may have a width slightly less than that of the channel so that the lower portion 10 may be inserted into the channel 4 from either end of the main body 1, and then easily slid/moved into a desired position along the channel. Then a user may rotate the manipulatable member 2, e.g. about 90°, until the cam surface 14 generally faces in the width direction of the channel 4. In the process of rotating the member 2 the side walls of the main body 1 which define the channel 4 are pushed apart somewhat by the cam surface 14, and the projection(s) 6 connected to the upper portions of the side walls are correspondingly rotated downward such that the free end(s)/edge(s) of the projection(s) are moved toward the flat or substantially flat support surface to reduce the width of the gap 9, thereby clamping/securing the edge(s) of one or more sheets of paper or other thin sheet material between the free end/edge of the projection and the flat or substantially flat support surface. To release the edge(s) of the sheet(s) of paper or other thin sheet material, the user may simply rotate the manipulatable member 2 until that the cam surface 14 is no longer pushing the side walls of the channel 4 apart, such that the projection(s) are rotated away from the flat or substantially flat support surface to increase the width of the gap 9.

As depicted in FIGS. 1, 2, 5, 7, the side walls of the main body 1 which define the channel 4 therebetween may be structured to they facilitate flexing of the side walls when pushed by the manipulatable member(s) 2 by having weakened portions at which flexing is facilitated. Particularly, in this embodiment, a pair of recesses 7 may be defined below the channel 4 such that lower portions of the side walls are relatively thin adjacent to the recesses, and when the manipulatable member(s) are rotated to push outward on the side walls, the side walls will primarily flex at the relatively thin lower portions thereof adjacent to the recesses 7. As depicted the recesses 7 may be substantially cylindrical in shape, but the recesses 7 may have any desired shape provided that they facilitate flexing of the side walls when pushed by the manipulatable member(s) 2.

While it may be sufficient to use only one manipulatable member 2 in association with the main body 1, any number of the manipulatable members 2 may be used, and generally the longer the main body 1 is, a larger number of manipulatable members may be used and spaced apart along the channel 4 to achieve a better, more uniform clamping pressure along the length of the projections 6. For example, if the main member is 6-8 inches long then two of the manipulatable members 2 may be sufficient to move the projections to exert appropriate clamping pressure on paper sheets or other sheet materials, whereas if the main member is 12 or more inches long, it may be desirable to use three or more of the manipulatable members 2.

As will be understood, the support device only requires a very small portion of a sheet material including an edge to be inserted into the gap 9 between the free edge of the projection 6 and the support surface, and to be clamped against the support surface by the free edge of the projection. At most, the portion of the sheet material inserted into the gap 9 would extend from the free edge of the projection 9 to the central flat bottom surface 5 of the main member. This is advantageous as the support device will not cover any significant portion of the sheet material or any indicia printed thereon. Further, based on the structure of the support device whereby edges of the papers or other thin sheets are clamped by the support device directly against the flat or substantially flat support surface, the papers or other sheet materials secured by the support will tend to lay flat against the support surface due to gravity. Hence, only one of the support devices securing an upper edge device will lay flushly against a vertically extending flat or substantially flat support surface of a sheet material would be sufficient to properly secure a sheet material in most cases. Of course, it is always possible to use a plurality of the support devices, e.g., one at the top edge of the sheet material and a second at the bottom edge of the sheet material or on opposite side edges of the sheet material, and this may be desirable if the support surface extends other than vertically or substantially vertically.

### Use of the Support Device

Use of the support device according to the exemplary embodiment of the invention is fairly simple. First, the main body 1 may be secured to any desired flat or substantially flat support surface using screws or other appropriate fastener(s). Screws may be inserted into the holes 8 for such purpose, and the heads of the screws may be sunk into the bottom wall of the main body 1 so that they do not project into the channel 4 and will not interfere with movement of the manipulateable member(s) 2 as they slide along the channel. One or more of the manipulatable members 2 may be provided at appropriate locations along the channel 4 of the main body and oriented such that the cam surfaces 14 of the lower portions thereof do not push the side walls of the main body outward. Edge(s) of one or more sheet materials may then be inserted into the gap 9 between the between the free end/edge of the projection 6 and support surface, and then the manipulateable member(s) 2 may be rotated such that the cam surface(s) 14 of the bottom portion(s) thereof push the side walls of the main body outward and the free edge of the projections 6 are thereby rotated to reduce the width of the gap 9 and thereby clamp the edge(s) against the support surface. For releasing the sheet material(s), the manipulateable member(s) 2 are simply rotated so that the cam surface no longer pushes the side walls of the main member outward, thereby increasing the width of the gap 9 and releasing the clamping pressure on the sheet material(s).

The support device according to the embodiment of FIGS. 1-7 is very advantageous because it can be used and reused for easily securing thin sheets such as notices and posters against a flat or substantially flat support surface such that the thin sheets may be observed and read by persons in the vicinity of same, and for easily releasing the thin sheets when desired. Also, it is relatively non-complicated and may be inexpensively manufactured.

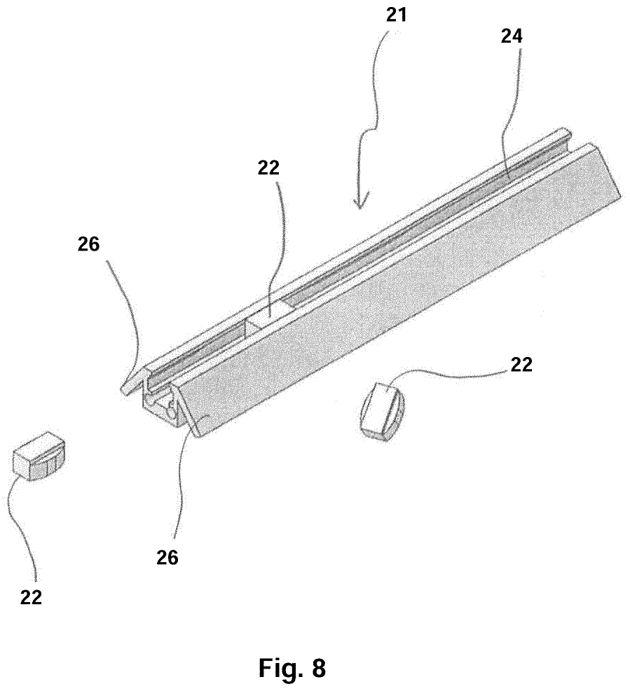

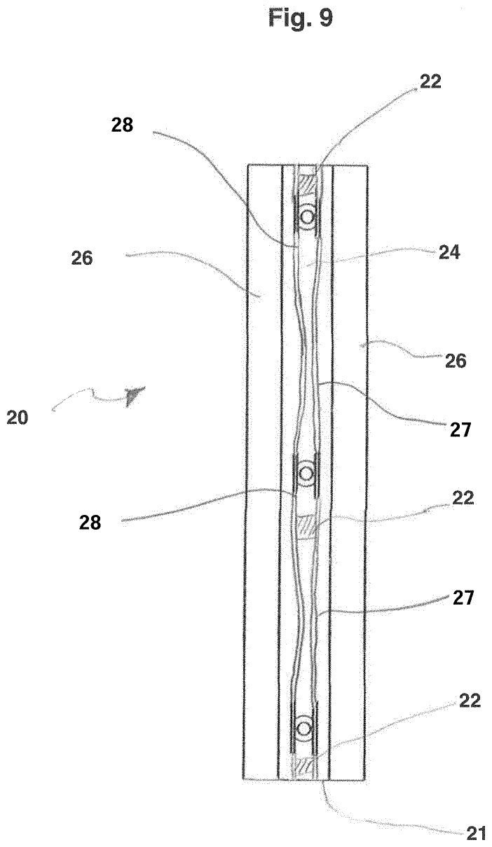

Referring to FIGS. 8-9, there are shown top perspective and plan views of another exemplary embodiment of a support device 20 according to the present invention. The basic structure and operation of the support device according to this embodiment is very similar to the support device according to the exemplary embodiment of FIGS. 1-7, e.g., a main body 21 of the support device has a central channel 24 which extends along its longitudinal length and projections 26 which project outward and downward from upper portions of the side walls of the main body, and one or more manipulateable member(s) 22 are slidably disposed in the channel 24 so that they may slide along the channel to any desired position(s). In this embodiment, like the first embodiment, the channel 24 may be open at opposite ends of the main body 21, as well as open upward, so that the manipulateable member(s) 22 may be operatively connected to the main body by being slid into the channel from either end of the main body, or one or both of the ends of the channel may be closed. Again, the manipulateable member(s) 22 may be provided integrally with the main body 21 of the support device such that there is no need for the manipulateable member(s) 22 be attached to and detached from the main body 21. In this embodiment the channel 24 in the main body 21 may have sections 27, 28 with different widths along its longitudinal length and the manipulateable member(s) 22 may slide along the channel 24 so that when the manipulateable member(s) 22 are slid to wider sections(s) 28 of the channel they do not push the side walls of the main body outward and do not reduce the width of the gap (release position), but when slid to narrower sections(s) 27 of the channel 24 they do push the side walls of the main body outward reducing the width of the gap (clamping position). As depicted, the manipulateable member(s) 22 in this embodiment are shorter and more compact than the manipulateable member(s) 2 in the first embodiment, and the member(s) 22 do not include any portion that projects outside of the channel 24 such as the upper grippable portion 12 in the first embodiment. Not having any projecting portion on the manipulateable member(s) 22 is desirable to prevent people or foreign objects from inadvertently engaging the manipulateable member(s) 22.

The support device of the embodiment of FIGS. 8-9 is very easy to use similarly to the support device according to the first embodiment of FIGS. 1-7, and achieves the same advantages of the support device in the embodiment of FIGS. 1-7.

The present invention is not limited in its application to the details of construction and to the dispositions of the components set forth in the foregoing description or illustrated in the appended drawings in association with the present exemplary embodiments of the invention. The present invention is capable of other embodiments and of being practiced and carried out in various ways. In addition, it is to be understood that the phraseology and terminology employed herein are for the purposes of illustration and example, and should not be regarded as limiting.

As such, those skilled in the art will appreciate that the concepts, upon which this disclosure is based, may readily be utilized as a basis for the designing of other structures, methods and systems for carrying out the several purposes of the present invention. It is important, therefore, that the claims be regarded as including such equivalent constructions

Although the present invention has been described herein with respect to specific illustrative embodiment, the foregoing description is intended to illustrate, rather than to limit the invention. Those skilled in the art will realize that many modifications of the preferred embodiment could be made which would be operable. All such modifications, which are within the scope of the claims, are intended to be within the scope and spirit of the present invention.

I claim:

1. A support device for securing sheet materials to a support surface, comprising:
an elongate main body having a side wall which connects top and bottom surfaces of the main body and a channel which extends in a longitudinal direction along a central portion of the main body's top surface;
a manipulateable member which is configured to be operatively connected in the channel and to be moved relative to the channel; and
a fastener which secures the main body to the support surface, wherein
the bottom surface of the main body is flat or substantially flat and is configured to flushly engage the support surface when the main body is secured to the support surface,
the main body includes a projection which extends from a portion of the side wall outward and at an angle to the side wall, the projection having a free end which is normally disposed at a level which is slightly different from a level of the bottom surface of the main body so that when the main body is attached to the support surface a gap will be defined between the free end of the projection and the support surface, and
the manipulateable member and the channel are configured such that when the main body is fastened to the support surface and the manipulateable member is moved relative to the channel the portion of the side wall from which the projection extends is also moved and changes a width of the gap defined between the free end of the projection and the support surface.

2. The support device according to claim 1, wherein the channel has a substantially uniform width along the longitudinal direction of the main body, the manipulatable member has first portion which is configured to be operatively disposed in the channel in engagement with a surface of the channel and a second portion which is configured to be manipulated by a user for moving the manipulatable member relative to the main body, and the first portion has a cam surface provided therewith which selectively engages the channel surface when the manipulatable member is moved relative to the main body to thereby change the width of the gap defined between the free end of the projection and the support surface.

3. The support device according to claim 2, wherein the second portion of the manipulatable member extends outside of the channel when the first portion is operatively disposed in the channel, and the second portion is configured to be gripped and manipulated by a user.

4. The support device according to claim 1, wherein the channel has a varying width along the longitudinal direction of the main body including wide and narrow portions, when the manipulateable member is connected in the channel and is moved to the narrow portion of the channel the manipulateable member pushes the side wall of the main body outward to thereby cause the width of the gap to be smaller, and when the manipulateable member is moved to the wide portion of the channel the manipulateable member does not push the side wall outward to thereby cause the width of the gap to be larger.

5. The support device according to claim 1, wherein the side wall of the main body has a weakened portion at which the side wall flexes when the manipulateable member is moved relative to the channel.

6. The support device according to claim 5, wherein the channel opens upward in the top surface of the main body, the portion of the side wall to which the projection is connected is near the top surface of the main body, and the weakened portion of the side wall is near the bottom surface of the main body.
